(19) United States
(12) Patent Application Publication
(10) Pub. No.: US 2004/0131762 A1
(43) Pub. Date: Jul. 8, 2004

(54) Manufacturing of a high-capacitance capacitor

(76) Inventors: Philippe Vigie, Pernay (FR); Guillaume Guegan, Tours (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/740,184

(22) Filed: Dec. 18, 2003

(30) Foreign Application Priority Data
Dec. 20, 2002 (FR) 02/16306

(51) Int. Cl. B05D 5/12; B05D 3/02; B05D 1/36

(52) U.S. Cl. 427/79; 427/128; 427/372.2; 427/402

(57) ABSTRACT

A method for manufacturing a capacitor on a single-crystal silicon substrate, comprising the steps of:

forming a silicon oxide layer;

depositing and completely oxidizing a titanium layer;

depositing a platinum layer of a thickness ranging between 800 and 1200 Å, intended to form a first electrode of the capacitor, the platinum deposition being performed by sputtering at a pressure of 1.5×10⁵ Pa and at a temperature ranging between 360 and 600° C.;

performing an anneal under an oxidizing atmosphere at a temperature ranging between 650 and 800° C.;

depositing and oxidizing a thin layer of a ferroelectric material, intended to form the inter-electrode insulator of the capacitor; and

depositing a conductive layer, intended to form a second electrode of the capacitor.

### BACKGROUND OF THE INVENTION

1. Field of the Invention

The present invention relates to the manufacturing of capacitors in monolithic form. More specifically, the present invention relates to the forming of capacitors with a high capacitance on a silicon substrate.

2. Discussion of the Related Art

To increase the capacitance of capacitors formed in integrated circuit chips, it has been provided to use insulators of very high dielectric constant. In particular, it is now desired to use insulators made of ferroelectric materials.

FIG. 1 illustrates, in a partial simplified cross-section view, the structure of a conventional capacitor using such an insulator.

A bottom electrode BE is separated from a semiconductor silicon (Si) substrate 1 by a silicon oxide layer 2 (SiO₂) having a thickness on the order of 1 μm. Bottom electrode BE is formed of an inert conductive material, generally a platinum layer (Pt) having a thickness of approximately 100 nm. An insulator 3 with a high dielectric constant separates bottom electrode BE from a metallic front electrode FE, for example, made of platinum, of iridium, or of ruthenium. Insulator 3 is obtained by depositing a layer of approximately 20 nm of a ferroelectric material such as PbZr₄₈Ti₅₂ subsequently oxidized (PZTO). The oxidation of the ferroelectric material is performed by means of an anneal at relatively high temperatures generally on the order of from 600° C. to 700° C.

A disadvantage of previously-described capacitors is their poor results in tests of resistance against mechanical constraints of tearing type.

Another disadvantage of such capacitors is a high rate of electric malfunctions.

### SUMMARY OF THE INVENTION

The present invention aims at providing a method for forming a capacitor on a semiconductor substrate which overcomes the previously discussed disadvantages.

To achieve this object, the present invention provides a method for manufacturing a capacitor on a single-crystal silicon substrate, comprising the steps of:

forming a silicon oxide layer;

depositing and completely oxidizing a titanium layer;

depositing a platinum layer of a thickness ranging between 800 and 1200 Å, intended to form a first electrode of the capacitor, the platinum deposition being performed by sputtering at a pressure of 1.5×10⁵ Pa and at a temperature ranging between 360 and 600° C.;

performing an anneal under an oxidizing atmosphere at a temperature ranging between 650 and 800° C.;

depositing and oxidizing a thin layer of a ferroelectric material, intended to form the inter-electrode insulator of the capacitor; and

depositing a conductive layer, intended to form a second electrode of the capacitor.

According to an embodiment of the present invention, the deposition of the titanium layer is performed by sputtering to grow a thickness ranging between 50 and 300 nm.

According to an embodiment of the present invention, the sputtering is performed at a temperature of 100° C., at a pressure of about 2×10⁵ Pa.

According to an embodiment of the present invention, the ferroelectric material is an alloy of lead, zirconium, and titanium.

According to an embodiment of the present invention, the ferroelectric material is PbZr₄₈Ti₅₂.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 is a partial simplified transversal cross-section view of the structure of a capacitor;

FIGS. 2A, 2B, and 2C illustrate, in a partial simplified transversal cross-section view, different steps of a capacitor forming method according to an embodiment of the present invention.

### DETAILED DESCRIPTION

For clarity, same elements have been designated with same reference numerals in the different drawings. Further, as usual in the representation of integrated circuits, the drawings are not to scale.

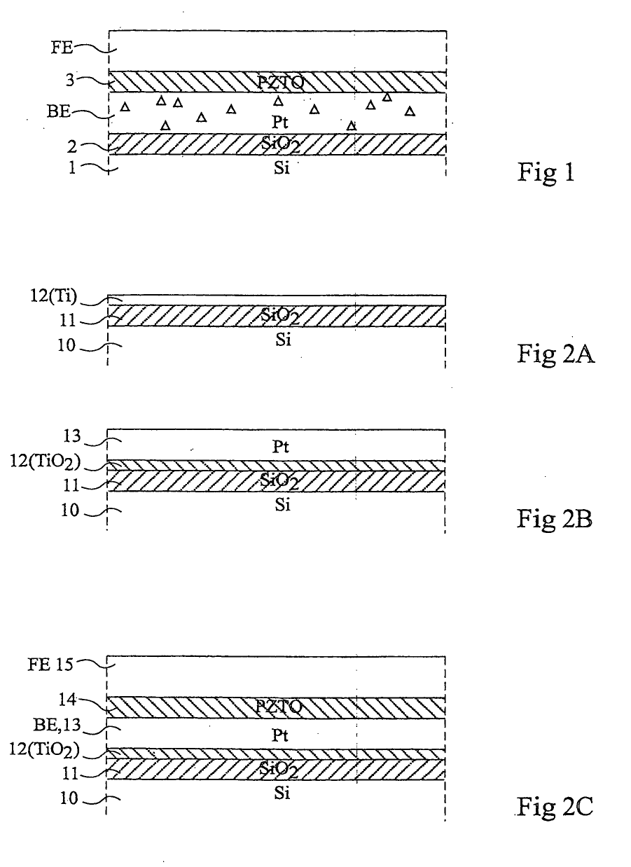

The present invention takes advantage of the studies of the present inventors on the origins of the malfunctions of a conventional structure. According to the present inventors, the malfunctions are linked to the oxidation at high temperature of the ferroelectric material, which results in conductivity defects in the electrode layer, as well as in lack of adherences between the electrode and the underlying and/or superposed insulating layers. These defects are linked to the presence in and on the bottom electrode (BE, FIG. 1) of point-shaped hillocks. These hillocks are represented in FIG. 1 by the triangles placed in bottom electrode BE. The occurrence of such hillocks is assumed to result from the following phenomenon. After a platinum deposition by conventional methods, bottom electrode BE exhibits two crystallographic orientation, one majority orientation <111> and one minority direction <220>. Each of the majority and minority lattices is stressed, in expansion, then in relaxation by the high temperature conditions, in the ferroelectric material oxidation step. These expansion/relaxation differences cause the forming of hillocks.

The inventors have also found that malfunctions are further increased in other known structures in which the platinum deposition is preceded by the deposition of a thin metal bonding layer intended to enhance the adherence of electrode BE. The bonding layer is then formed of a metal or of a metal alloy which easily adheres on the underlying insulator and to which the platinum easily adheres. According to the inventors, the increase in malfunctions, in terms of adherence as well as in terms of conductivity defects, should result from the combination of the two following phenomena, upon oxidation of the ferroelectric material. On the one hand, the very thin bonding layer oxidizes. This oxidation translates as the forming of protrusions at the interface between layer 2 and electrode BE, due to the high temperature as well as to the mechanical stress differences in the superposed materials. On the other hand, the material(s) of the bonding layer tend, due to the high temperature, to diffuse into all electrode BE, and even to its interface with the ferroelectric layer being oxidized where they form inclusions. Some of the inclusions oxidize in electrode BE, further enhancing conductivity defects. Other inclusions remain conductive and tend to cause a local depletion which results in conductivity continuity defects. Further, when the non-oxidized inclusions are in the vicinity of one of the two interfaces with an insulating layer, the depletion effect causes or enhances a lack of adherence.

Given the foregoing, the present invention aims at providing a capacitor forming method which enables eliminating the forming of hillocks, as well as of possible protrusions or metal inclusions, oxidized or not.

FIGS. 2A-C illustrate, in a partial simplified cross-section view, intermediary steps of the forming of a capacitor according to an embodiment of the present invention.

As illustrated in FIG. 2A, the method of the present invention starts with the forming, on a single-crystal silicon substrate 10 (Si), of a thick silicon oxide layer 11 (SiO₂). Then, a titanium layer 12 (Ti) is deposited. The titanium is deposited by sputtering over a thickness ranging between 5 and 50 nm, preferably on the order of 20 nm. The titanium is sputtered at a temperature on the order of 100° C., under a 2.10⁵ Pa pressure (approximately 2 mTorr).

At the next steps, the result of which is illustrated in FIG. 2B, the titanium of layer 12 is completely oxidized to obtain a rutile layer (titanium oxide, TiO₂). Preferably, the titanium oxidation is obtained by performing an anneal under an oxidizing atmosphere at a temperature ranging between 400 and 1000° C. for some fifteen minutes.

Then, a platinum layer 13 (Pt) is deposited over the entire structure. Layer 13, having a thickness from 80 to 120 nm, is deposited by sputtering at a temperature ranging between 360 and 600° C., preferably 400° C., at a pressure of 1.5×10⁵ Pa (1.5 mTorr). The structure thus obtained, shown in FIG. 2B, is then submitted to an anneal under an oxidizing atmosphere. This anneal, which is relatively long, on the order of from 30 to 75 minutes, is performed at a temperature greater than 650° C. and smaller than 800° C., preferably on the order of 700° C.

Then, as illustrated in FIG. 2C, the method carries on with the deposition and the oxidation, by an anneal under an oxidizing atmosphere between 600 and 1000° C., of a ferroelectric material, for example, PbZr₄₈Ti₅₂, to form a layer 14 of a dielectric (PZTO) of small thickness, ranging between 50 and 300 nm. Finally, the structure is completed with the deposition of a conductive material such as platinum, iridium or ruthenium. A capacitor formed of a platinum bottom electrode (BE) 13, of a dielectric 14, and of a front electrode (FE) 15 has thus been formed.

The forming sequence of the bottom electrode (BE) 13 enables considerably reduction of the amount of hillocks with respect to a conventional structure. In particular, the anneal subsequent to the sputtering enables the crystal structure of layer 13 to relax and direct exclusively along direction <111>.

The resulting capacitor advantageously exhibits better performances in tearing and electric tests than conventional devices.

Of course, the present invention is likely to have various alterations, modifications, and improvements which will readily occur to those skilled in the art. In particular, the forming of a capacitor by means of an inter-electrode dielectric of PZT type has been considered hereabove. However, the present invention applies to the forming of a capacitor comprising any dielectric obtained by oxidation of a ferroelectric material deposited on an inert platinum bottom electrode, such as PNZT, PLZT, SBT or BST.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for manufacturing a capacitor on a single-crystal silicon substrate (10), comprising the steps of:
forming a silicon oxide layer (11, SiO₂);
depositing and completely oxidizing a titanium layer (12, TiO₂);
depositing a platinum layer (13, Pt) of a thickness ranging between 800 and 1200 Å, intended to form a first electrode of the capacitor, the platinum deposition being performed by sputtering at a pressure of 1.5×10⁵ Pa and at a temperature ranging between 360 and 600° C.;
performing an anneal under an oxidizing atmosphere at a temperature ranging between 650 and 800° C.;
depositing and oxidizing a thin layer of a ferroelectric material, intended to form the inter-electrode insulator (14, PZTO) of the capacitor; and
depositing a conductive layer (15), intended to form a second electrode (FE) of the capacitor.

2. The method of claim 1, wherein the deposition of the titanium layer (12, Ti) is performed by sputtering to grow a thickness ranging between 50 and 300 nm.

3. The method of claim 2, wherein the sputtering is performed at a temperature of 100° C., at a pressure of about 2×105 Pa.

4. The method of claim 1, wherein the ferroelectric material is an alloy of lead, zirconium, and titanium.

5. The method of claim 4, wherein the ferroelectric material is PbZr₄₈Ti₅₂.
